(19) United States
(12) Patent Application Publication
(10) Pub. No.: US 2003/0041494 A1
(43) Pub. Date: Mar. 6, 2003

(54) Banner holder

(76) Inventor: Jay Steven Yucht, Jackson, NJ (US)

Correspondence Address: Thomas L. Adams, 120 Eagle Rock Avenue, P.O. Box 340, East Hanover, NJ, 07936, US

(21) Appl. No.: 10/165,970

(22) Filed: Jun. 11, 2002

Related U.S. Application Data
(60) Provisional application No. 60/317,128, filed on Sep. 6, 2001.

(51) Int. Cl. G09F 7/22

(52) U.S. Cl. 40/617; 40/906

(57) ABSTRACT

A greeting device has a case adapted for overhead mounting. A mistletoe object is attached to and suspended below the case. Also, a speaker is mounted at the case. A driver, including a sound playback device, is mounted in the case and coupled to the speaker. The playback device has stored therein a sound recording containing information related to the mistletoe object. The recording contains information concerning kissing. A proximity sensor is mounted at the mistletoe object outside the case. A proximity sensor, including a sensing head and a wire, is routed between the case and the sensing head. The sensing head dangles on the wire. The proximity sensor is coupled to the playback device for producing a proximity signal in response to arrival of a person. The playback device can play the sound recording through the speaker in response to the proximity signal.

### BACKGROUND OF THE INVENTION

1. Field of the Invention

The present invention relates to greeting devices, and in particular to devices, producing a recorded sound in response to a proximity detector.

2. Description of Related Art

Known proximity detectors are used for automated outdoor lights. These lights will illuminate when, for example, a pedestrian walks along a path or when a motor vehicle is driven into a driveway, in order to light the way for the motorist or pedestrian.

A variety of amusement devices have employed a proximity detector to trigger sound or motion in an animated figure. For example, an animated fish, flower, or Santa Claus will move to prerecorded music when a person comes near the device.

Sounds can be digitally recorded in various types of memory. In a personal computer, the user may record through a microphone into random access memory. Digital sound patterns can also be stored in less volatile memory such as EEPROM, or ROM.

Installing a proximity detector in certain environments can be difficult. When a proximity detector is installed in an overhead location, care must be taken to ensure that the detector has sensitivity appropriate for an overhead location. Also, the detector must be able to function without interference.

Hanging mistletoe at or near a doorway is a holiday tradition that is done with either real or artificial mistletoe. The tradition involves couples kissing under the mistletoe. The mistletoe is often unobtrusive and guests may not notice the mistletoe and therefore never practice this holiday tradition.

Accordingly, there is a need for a greeting device that can operate in various environments including overhead locations or environments where there are potential obstructions, such as mistletoe.

### SUMMARY OF THE INVENTION

In accordance with the illustrative embodiments demonstrating features and advantages of the present invention, there is provided a greeting device including a case adapted for overhead mounting, and an object suspended below the case. A speaker is mounted at the case. Also provided is a driver, including a sound playback device, coupled to the speaker and having stored therein a sound recording containing information related to the object. The greeting device includes a proximity sensor coupled to the playback device for producing a proximity signal in response to arrival of a person. The playback device is operable to play the sound recording through the speaker in response to the proximity signal.

In accordance with another aspect of the invention, a greeting device is provided with a speaker, a case and a mistletoe object attached to the case. Also provided is a driver, including a sound playback device, mounted in the case and coupled to the speaker. The playback device has stored therein a sound recording containing information related to the mistletoe object. The greeting device also includes a proximity sensor coupled to the playback device for producing a proximity signal in response to arrival of a person. The playback device is operable to play the sound recording through the speaker in response to the proximity signal.

In accordance with yet another aspect of the invention, a greeting device is provided with a speaker, a case, and an object attached to and spaced from the case. Also provided is a driver, including a sound playback device, mounted in the case and coupled to the speaker. The playback device has stored therein a sound recording containing information related to the object. The greeting device also includes a proximity sensor mounted at the object outside the case. The proximity sensor is coupled to the playback device for producing a proximity signal in response to arrival of a person. The playback device is operable to play the sound recording through the speaker in response to the proximity signal.

By employing apparatus of the foregoing type, an improved greeting device is achieved. In a preferred embodiment, a case containing digital electronics can playback a message. A proximity sensor suspended from a wire dangling from the case can sense the arrival of person and begin playback in response.

In this preferred embodiment artificial mistletoe may be suspended from the case, which is mounted overhead. The device can playback a message related to the mistletoe when the arrival of person is detected. For example, the device can issue the greeting “kiss me,” followed by holiday music.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is a perspective view of a greeting device in accordance with principles of the present invention;

FIG. 2 is a perspective view of the device of FIG. 1 with its mistle toe object removed and shown as an exploded fragment;

FIG. 3 is a perspective view of a fragment of a case and object that is an alternate to that of FIG. 2;

FIG. 4 is an exploded view of the device of FIG. 2 with the mistletoe object removed; and

FIG. 5 is a schematic diagram of electronic components inside the case of FIG. 1.

### DETAILED DESCRIPTION OF THE PREFERRED EMBODIMENTS

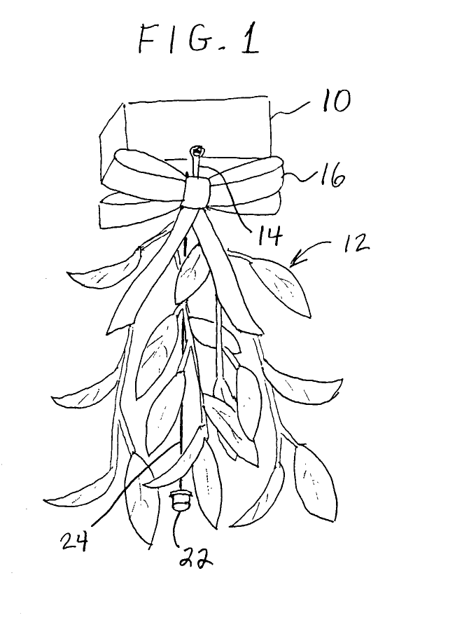

Referring to FIGS. 1 and 2, an exemplary greeting device is shown as a case 10 supporting a mistletoe object 12. Object 12 may be an artificial sprig of mistletoe made of molded plastic. Case 10 the shown as a small rectangular plastic package, approximately four inches (10.2 cm) long, although cases of different materials, sizes and shapes may be employed instead.

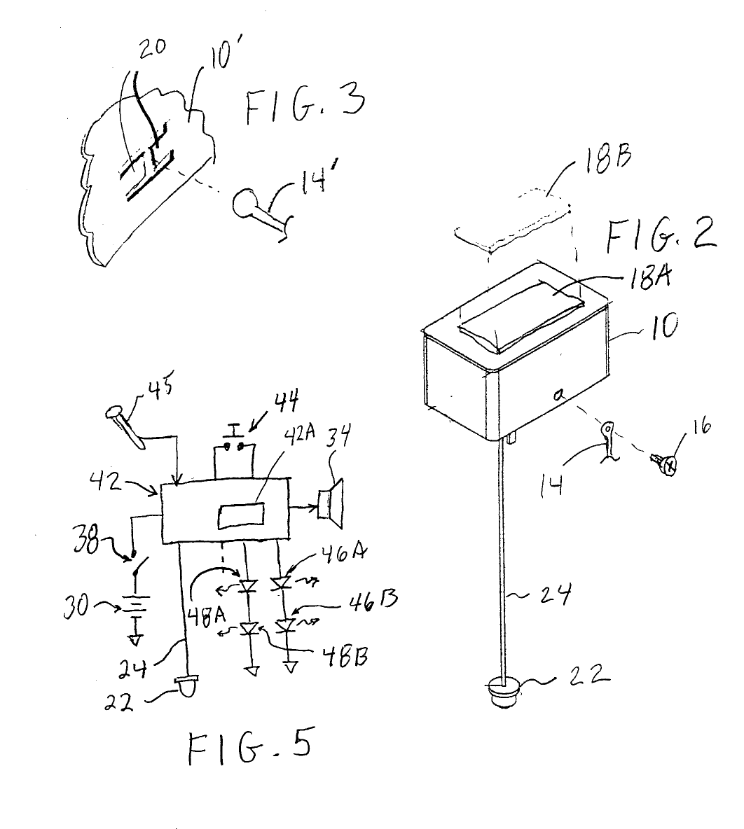

Object 12 is shown with an upper stem 14, terminating in an eye that is used to secure object 12 to case 10 by means of screw 16. While object 12 is shown attached to the face of case 10 other attachment points are possible. For example in FIG. 3, the end 14′ of an alternate object is shown terminated in a rounded bulb that attaches to the underside of case 10′. Case 10′ is shown herein with an “H” shaped slit that forms two opposing tabs 20. Bulbous end 14′ can be pushed past tabs 20 to deflect them, so that end 14′ is locked inside case 10′ between tabs 20.

Object 12 is shown decorated with a ribbon 16. Other supplemental or alternative decorations are contemplated, including jingle bells. It will also be appreciated that objects other than mistletoe objects can be attached to case 10 in alternate embodiments.

Case 10 is designed to be attached overhead to a ceiling, the arch of a doorway, etc. Case 10 is adapted for such purposes in this embodiment by employing a pair of hook and loop fasteners 18A and 18B (for example, Velcro™ fasteners), although other types of fasteners are contemplated.

Case 10 is fitted with a proximity sensor, shown herein as a sensing head 22 suspended on a wire 24 dangling from the underside of case 10. In some embodiments the sensing head will be attached to a separate rod and wires will be routed through or around the rod. Such a mounting can position the sensing head 22 at the bottom of the mistletoe object 12, giving sensing head 22 an unobstructed downward clearance.

Sensing head 22 may be a small photodetector that essentially detects the arrival of a person by sensing changes in light intensity; that is, changing shadows or highlights. More sophisticated sensing heads may employ an infrared detector that responds to an increase in infrared radiation caused by body heat. Various other types of proximity detectors may be employed, including imaging devices, ultrasonic reflection detecting systems, etc. Also, sensing head 22 need not be subjacently suspended in all embodiments. In some instances the sensing head may be mounted directly on the surface of the case 10, so long as allowance is made for any interference caused by mistletoe object 12.

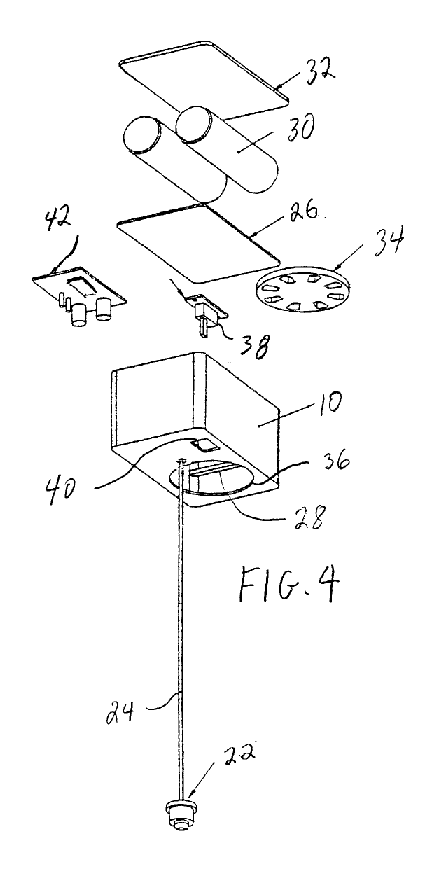

Referring to FIG. 4, case 10 is divided into an upper and lower compartment by divider 26, which is held in a middle position by shelf 28. Batteries 30 are mounted in the upper compartment above divider 26 and are held in place by removable cover 32.

Speaker 34 will be mounted in the lower compartment of case 10 at circular opening 36. Also, on/off power switch 38 will be mounted in opening 40 in case 10. In addition, a driver 42 will be mounted on printed circuit board. This driver 42 will have a number of electronic components, including a digital memory for storing a sound recording. The driver will act as a sound playback device.

Referring to FIG. 5, previously mentioned driver 42 is shown providing an output to previously mentioned speaker 34. Previously mentioned batteries 30 are shown serially connected through power switch 38 between ground and a power input of driver 42. Previously mentioned sensing head 22 is shown connected through wire 24 to driver 42. Driver 42 is also shown connected to optional pushbutton key 44 and optional microphone 45, whose functions will be described presently. A number of optional strings of lamps are shown herein as serially connected LEDs 46A and 46B and serially connected LEDs 48A and 48B. These LEDs are connected cathode to anode with the cathodes of LEDs 46B and 48B grounded.

To facilitate an understanding of the principles associated with the foregoing apparatus, its operation will be briefly described. Velcro™ pad 18B has adhesive backing, used to secure pad 18B overhead to a ceiling, doorway, or the like. Case 10 is then lifted into place so that pad 18A fastens to pad 18B. Power switch 38 may then be switched to the “on” position.

When a person arrives near artificial mistletoe object 12, sensing head 22 detects the presence of that person and transmits a proximity signal to driver 42 (FIGS. 4 and 5). Driver 42 responds by retrieving digitally storage sound recording information and recomposing that digital information into a time varying electronic waveform. This waveform is then amplified and used to drive speaker 34. In a preferred embodiment speaker 34 will issue the greeting “kiss me,” followed by a holiday tune. Alternate spoken messages are contemplated, such as “happy holidays”, “merry Christmas”, “welcome to our home”, etc. The sound recording in other embodiments may be a spoken message only or a musical recording only.

In some embodiments driver 42 may have a number of discrete recordings that are played back in sequence. Thus, the first person arriving will hear a first recorded greeting, the second person arriving will hear a second recorded greeting, etc. When the last recorded greeting is played back, the sequence will repeat so that the first recorded greeting will be played back next. Alternatively, the driver 42 will proceed to the next recorded greeting only if the user depresses pushbutton key 44 (FIG. 5). Therefore, the user can effectively select the specific greeting to correspond to different holidays or different social activities.

In still other embodiments, the user may record a custom greeting. Specifically, the user may depress a key (such as pushbutton key 44) and speak or play music into microphone 45. The sound captured by microphone 45 will then be digitally stored in memory chip 42A, which may be an EEPROM. Alternatively, chip 42A may be removable, read-only memory (ROM), containing a greeting prerecorded by a manufacturer. Thus, a user can purchase a replacement chip 42A and install it in driver 42 in order to change the greeting. When the greeting is changed, the user may also replace the mistletoe object 12 appropriately; for example, shamrocks for a St. Patrick's Day greeting in gaellic, dreidles for a Hanukkah greeting, toy football for a team cheer on superbowl Sunday, toy mascot of a political party for a campaign slogan, etc.

In embodiments having the optional LEDs, lamps 46A, 46B, 48A, and 48B can illuminate either continuously or intermittently when driver 42 is producing a sound through speaker 34. In some embodiments the LEDs will flash in time to music played through speaker 34. Typically, the LEDs will be placed around the object 12 to draw attention to the object.

Obviously, many modifications and variations of the present invention are possible in light of the above teachings. It is therefore to be understood that within the scope of the appended claims, the invention may be practiced otherwise than as specifically described.

1. A greeting device comprising:
a case adapted for overhead mounting;
an object suspended below said case;
a speaker mounted at said case;
a driver including a sound playback device coupled to said speaker and having stored therein a sound recording containing information related to said object; and
a proximity sensor coupled to said sound playback device for producing a proximity signal in response to arrival of a person, said sound playback device operable to play said sound recording through said speaker in response to said proximity signal.

2. A greeting device according to claim 1 wherein said object comprises a mistletoe object, said recording containing information concerning kissing.

3. A greeting device according to claim 1 wherein said object comprises a mistletoe object, said recording containing an instruction to kiss.

4. A greeting device according to claim 1 wherein said object comprises a mistletoe object, said recording containing musical information.

5. A greeting device according to claim 1 wherein said recording contains an instruction to kiss and information concerning a holiday, including musical information.

6. A greeting device according to claim 1 comprising:
a pair of hook and loop fasteners, one attached to said case, the other adapted for ceiling mounting

7. A greeting device according to claim 1 wherein said sound playback device has a plurality of discrete recorded segments, said sound playback device being operable to manually select one of said recorded segments for playback in response to said proximity signal.

8. A greeting device according to claim 1 wherein said playback device has a plurality of discrete recorded segments that play successively on successive occurrences of said proximity signal.

9. A greeting device according to claim 1 comprising:
a microphone coupled to said playback device for recording therein a personalized message.

10. A greeting device according to claim 1 comprising:
a plurality of lamps coupled to and driven by said driver to illuminate when said playback device plays said sound recording.

11. A greeting device according to claim 1 comprising:
a plurality of lamps coupled to and driven by said driver to flash.

12. A greeting device according to claim 1 comprising:
at least one lamp having a wire connected to and driven by said driver, said lamp being suspended on said wire.

13. A greeting device comprising:
a case;
a mistletoe object attached to said case;
a speaker;
a driver including a sound playback device mounted in said case and coupled to said speaker, said playback device having stored therein a sound recording containing information related to said mistletoe object; and
a proximity sensor coupled to said playback device for producing a proximity signal in response to arrival of a person, said playback device operable to play said sound recording through said speaker in response to said proximity signal.

14. A greeting device according to claim 13 wherein said recording contains information concerning kissing.

15. A greeting device according to claim 13 wherein said recording contains an instruction to kiss.

16. A greeting device according to claim 13 wherein said recording contains musical information.

17. A greeting device according to claim 13 wherein said recording contains an instruction to kiss and information concerning a holiday, including musical information.

18. A greeting device comprising:
a case;
an object attached to and spaced from said case;
a speaker;
a driver including a sound playback device mounted in said case and coupled to said speaker, said playback device having stored therein a sound recording containing information related to said object; and
a proximity sensor mounted at said object outside said case, said proximity sensor being coupled to said playback device for producing a proximity signal in response to arrival of a person, said playback device operable to play said sound recording through said speaker in response to said proximity signal.

19. A greeting device according to claim 18 wherein said proximity sensor includes a sensing head and a wire routed between said case and said sensing head.

20. A greeting device according to claim 19 wherein said sensing head is supported at least partially by said wire.

21. A greeting device according to claim 19 wherein said sensing head is dangling from said wire.

22. A greeting device according to claim 18 wherein said object comprises a mistletoe object, said recording containing information concerning kissing.

23. A greeting device according to claim 18 wherein said object comprises a mistletoe object, said recording containing an instruction to kiss.

24. A greeting device according to claim 18 wherein said object comprises a mistletoe object, said recording containing musical information.

25. A greeting device according to claim 18 wherein said recording contains an instruction to kiss and information concerning a holiday, including musical information.

26. A greeting device comprising:
a case adapted for overhead mounting;
a mistletoe object attached to and suspended below said case;
a speaker mounted at said case;
a driver including a sound playback device mounted in said case and coupled to said speaker, said playback device having stored therein a sound recording containing information related to said mistletoe object, said recording containing information concerning kissing; and
a proximity sensor mounted at said object outside said case, said proximity sensor including a sensing head and a wire routed between said case and said sensing head, said sensing head dangling on said wire, said proximity sensor being coupled to said playback device for producing a proximity signal in response to arrival of a person, said playback device operable to play said sound recording through said speaker in response to said proximity signal.
